(19) United States
(12) Patent Application Publication
(10) Pub. No.: US 2003/0165048 A1
(43) Pub. Date: Sep. 4, 2003

(54) Enhanced light-generated interface for use with electronic devices

(76) Inventors: Cyrus Bamji, Fremont, CA (US); James D. Spare, San Francisco, CA (US); Abbas Rafii, Palo Alto, CA (US); Michael Van Meter, Danville, CA (US); John Bacus, San Francisco, CA (US); Helena Roeber, Palo Alto, CA (US); Cheng-Feng Sze, Cupertino, CA (US); Apurva Desai, Fremont, CA (US)

Correspondence Address: HICKMAN PALERMO TRUONG & BECKER, LLP, 1600 WILLOW STREET, SAN JOSE, CA, 95125, US

(21) Appl. No.: 10/315,908

(22) Filed: Dec. 9, 2002

Related U.S. Application Data
(60) Provisional application No. 60/340,005, filed on Dec. 7, 2001.
(60) Provisional application No. 60/424,095, filed on Nov. 5, 2002.
(60) Provisional application No. 60/357,733, filed on Feb. 15, 2002.

(51) Int. Cl. G06F 1/16

(52) U.S. Cl. 361/681

(57) ABSTRACT

A light-generated input interface is provided using a combination of components that include a projector and a sensor. The projector displays an image corresponding to an input device. The sensor can be used to detect selection of input based on contact by a user-controlled object with displayed regions of the projected input device. An intersection of a projection area and an active sensor area on a surface where the input device is to be displayed is used to set a dimension of an image of the input device.

### RELATED APPLICATION AND PRIORITY INFORMATION

This application claims benefit of priority to Provisional U.S. Patent Application No. 60/340,005, entitled “Design For Projected 2-Dimensional Keyboard,” filed Dec. 7, 2001; to Provisional U.S. Patent Application No. 60/424,095, entitled “Method For Creating A Useable Projection Keyboard Design,” filed Nov. 5, 2002; and to Provisional U.S. Patent Application No. 60/357,733, entitled “Method and Apparatus for Designing the Appearance, and Defining the Functionality and Properties of a User Interface for an Input Device”, filed Feb. 15, 2002. All of the aforementioned priority applications are hereby incorporated by reference in their entirety for all purposes.

### FIELD OF THE INVENTION

The present invention relates to an interface for electronic devices. In particular, the present invention relates to a light-generated input interface for use with electronic devices.

### BACKGROUND OF THE INVENTION

It is often desirable to use virtual input devices to input command and/or data into electronic systems, such as for example a computer system, a musical instrument, or a telephone. For example, although computers can now be implemented in almost pocket-size form factors, inputting data or commands on a mini-keyboard can be time consuming, awkward, and error prone. While many cellular telephones today can handle e-mail communication, actually inputting messages using their small touch pads can be difficult. A personal digital assistant (PDA) has much of the functionality of a computer but suffers from a tiny or non-existent keyboard.

Some interest has been shown to develop virtual interfaces for such small form-factor devices. A device with a virtual interface could determine when, for example, a user's fingers or stylus selects input based on a position where the user contacts a surface where the virtual interface is provided. For example, in the context of a virtual keyboard, sensors incorporated into the device would detect which key was contacted by the user's finger or stylus. The output of the system could perhaps be input to a device such as a PDA, in lieu of data that could otherwise be received by a mechanical keyboard. (The terms “finger” or “fingers”, and “stylus” are used interchangeably throughout this application.) In this example a virtual keyboard might be provided on a piece of paper, perhaps that unfolds to the size of a keyboard, with keys printed thereon, to guide the user's hands. It is understood that the virtual keyboard or other input device is simply a work surface and has no sensors or mechanical or electronic components. The paper and keys would not actually input information, but the interface of the user's fingers with portions of the paper, or if not paper, portions of a work surface, whereon keys would be drawn, printed, or projected, could be used to input information to the PDA. A similar virtual device and system might be useful to input e-mail to a cellular telephone. A virtual piano-type keyboard might be used to play a real musical instrument.

### BRIEF DESCRIPTION OF THE DRAWINGS

Embodiments of the invention are illustrated by way of example, and not by way of limitation, in the figures of the accompanying drawings. Like reference numerals are intended to refer to similar elements among different figures.

FIG. 1 illustrates a light-generated interface for an electronic device, where the light-generated interface is in the form of a keyboard, under an embodiment of the invention.

FIG. 2A is a top view illustrating an area where a light-generated interface is provided, under an embodiment of the invention.

FIG. 2B is a side view of a handheld computer configured to generate an input interface from light, under an embodiment of the invention.

FIG. 3A is a first illustration of a light-generated keyboard, under an embodiment of the invention.

FIG. 3B is another illustration of a light-generated keyboard, under an embodiment of the invention.

FIG. 3C is another illustration of a light-generated keyboard incorporating a mouse pad, under an embodiment of the invention.

FIG. 3D is another illustration of a light-generated interface in the form of a handwriting recognition area, under an embodiment of the invention.

FIG. 4 illustrates a method for determining the operable area for where a light-generated input device can be displayed.

FIG. 5 illustrates a method for customizing a light-generated input interface for use with an electronic device.

FIG. 6 illustrates a method by which an output image of a projector can be corrected, under an embodiment of the invention.

FIG. 7 illustrates a portion of a light-generated keyboard prior to correction.

FIG. 8 illustrates the portion of a light-generated keyboard after correction has been performed.

FIG. 9 illustrates a hardware diagram of an electronic device that incorporates an embodiment of the invention.

### DETAILED DESCRIPTION OF THE INVENTION

Embodiments of the invention describe a light-generated input interface for use with an electronic device. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

A. Overview

A light-generated input interface is provided using a combination of components that include a projector and a sensor system. The projector displays an image that indicates one or more input areas where placement of an object is to have a corresponding input. The sensor system can be used to detect selection of input based on contact by a user-controlled object with regions displayed by the projector. An intersection of a projection area and an active sensor area on a surface where the input areas are being displayed is used to set a dimension of the image.

According to one embodiment, an electronic input device is provided having a sensor system and a projector. The sensor system is capable of providing information for approximating a position of an object contacting a surface over an active sensing area. The projector is capable of displaying an image onto a projection area on the surface. The image provided may be of any type of input device, such as of a keyboard, keypad (or other set of keys), a pointer mechanism such as a mouse pad or joy stick, and a handwriting recognition pad. One or both of the sensor system and the projector are oriented so that the image appears within an intersection of the active sensing area and the projection area.

As used herein, the term “electronic input device” corresponds to any electronic device that incorporates or otherwise uses an input mechanism such as provided with embodiments described herein.

The term “projector” refers to a device that projects light.

An “active sensing area” refers to a maximum area of a surface where a sensor system can effectively operate. The performance level at which the sensor system is to operate over a given area in order for the given area to be considered the active sensing area may be a matter of design choice, or alternatively set by conditions or limitations of the components for the interface, or the surface where the sensor system is to operate.

A “projection area” refers to a maximum area of a surface where a projector can effectively display light in the form of a particular pattern or image. The performance level at which the projector is to operate over a given area in order for the given area to be considered the projection area may also be a matter of design choice, or alternatively set by conditions or limitations of the components for the interface, or the surface where the sensor system is to operate.

An “image” refers to light forming a pattern or detectable structure. In one embodiment, an image has a form or appearance of an object, such as a keyboard.

While embodiments described herein provide for an input interface that is displayed in the form of an image for a projector, alternative embodiments may use other mediums for displaying or otherwise providing an interface. For example, an input interface may be in the form of a tangible medium, such as an imprint on a surface such as a piece of paper. The concepts described below would be equally applicable to the instance where the sensor system and processing resources are used in conjunction with a tangible medium that provides an image of the interface. For example, a surface that has a keyboard drawn on it may substitute for a projected interface image. The size of the keyboard image, or where it is positioned in relation to a sensor system may be determined as described below. Still further, no specific image of an interface may be provided, other than an indication of where the image resides.

B. Keyboard Implementation

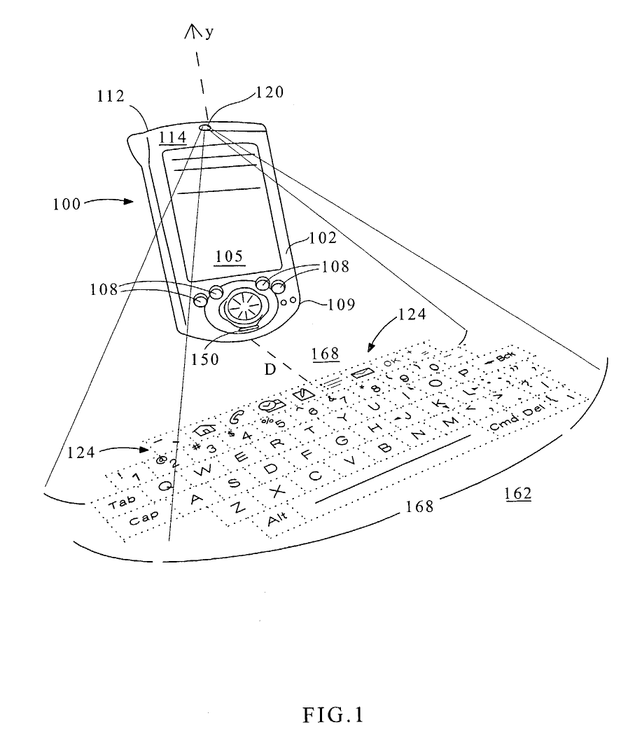

FIG. 1 illustrates a light-generated input mechanism for use with an electronic device, under an embodiment of the invention. In FIG. 1, components for creating the input interface are incorporated into a handheld computer 100, such as a personal digital assistant (PDA). When activated, the handheld computer 100 provides a light-generated interface that has the form of an input device. A user may interact with the input device in order to enter input or otherwise interact with the handheld computer 100. The handheld computer 100 is provided as one example of an application where the light-generated input interface can be used. Other embodiments may be implemented with, for example, other types of portable computers and electronic devices. For example, other devices that can incorporate a light-generated input interface as described herein include pagers, cellular phones, portable electronic messaging devices, remote controls, electronic musical instruments and computing apparatuses for automobiles.

A typical application for a light-generated input interface is a portable computer, which includes PDA, laptops and other computers having an internal power supply. Such an input interface reduces the need for portable computers to accommodate physical input interfaces such as keyboards, handwriting recognition areas and mouse pads. As a result, the overall form factors for portable computers can be reduced. Furthermore, the portability of such computers is also enhanced.

In FIG. 1, the light-generated input interface is in the form of a keyboard 124. The keyboard 124 is shown as being in a QWERTY format, although other types of key arrangements may be used and provided. For example, as an alternative, any set of numeric or alphanumeric keys may be displayed instead of keyboard 124. The keyboard 124 is projected onto a surface 162. A user controls an object (such as a finger or stylus) to make contact with the surface 162 in regions that correspond to keys of the keyboard 124. The handheld computer 100 uses resources provided by the light-generated input interface to determine a key selected from the keyboard 124. A particular key may be selected by the user-positioning the object to make contact with the surface 162 over a region represented by that key.

According to one embodiment, handheld computer 100 includes a projector 120 that displays keyboard 124. The projector 120 may project visible light to create an image of keyboard 124. The image may delineate individual keys of the keyboard, as well as markings that appear on the individual keys. In an embodiment, the projector 120 comprises a laser light source and a diffractive optical element (DOE). The DOE diffracts a laser beam produced by the laser. The diffraction achieves the result of forming an image, which may be cast to appear on the surface 162. The area of surface 162 that corresponds to a maximum range by which the components of the projector 120 can effectively be cast is the projection area. As will be described in greater detail, the actual area where the image is provided does not necessarily correspond to the projection area, but rather to a portion of the projection area where the user's interaction can effectively be determined.

The projector 120 may be provided on a front face 102 of handheld computer 100 adjacent to a display 105. One or more application buttons 108 are provided on front face 102. The handheld computer 100 may be configured to stand at least partially upright, particularly when the keyboard 124 is activated. To this end, a bottom surface 109 of the handheld computer 100 may be configured or otherwise provided a structure to enable the handheld computer to stand at least partially upright. A bottom surface 109 of handheld computer 100, or other structure associated with the handheld computer, may be configured to enable the handheld computer to stand at least partially upright. For example, a stand may support the handheld computer from a back side to prop the handheld computer 100 up on the bottom surface 109. Alternatively, the handheld computer 100 may rest on a cradle. An axis Y represents a length-wise axis of handheld computer 100.

A top portion 114 of handheld computer 100 refers to a region between a top side of the display 105 and a top edge 112 of the handheld computer. In one embodiment, the projector 120 is provided centrally on the top region 114 and projects light downward. The light from the projector 120 creates an image corresponding to keyboard 124. The projector 120 is cast downward so that the keyboard 124 may be formed on the surface 162 a distance D from the front face 102.

A sensor system 150 has an active sensor area 168 on surface 162. The sensor system 150 is used to detect placement of the user-controlled object onto one of the regions delineated by keys of keyboard 124. The sensor can only sense the object contacting surface 162 when the object is within active sensor area 168. The active sensor area 168 may be defined by a viewing angle and by a maximum distance by which sensor system 150 can detect the user's placement of the object.

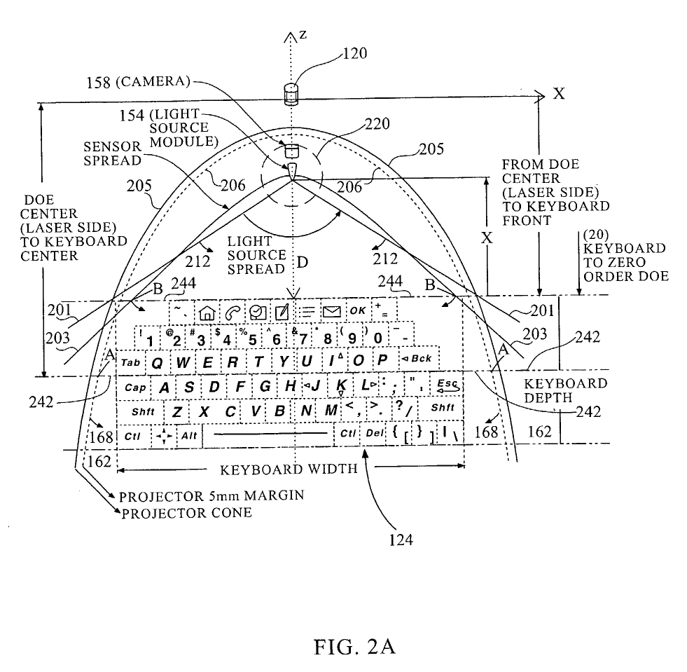

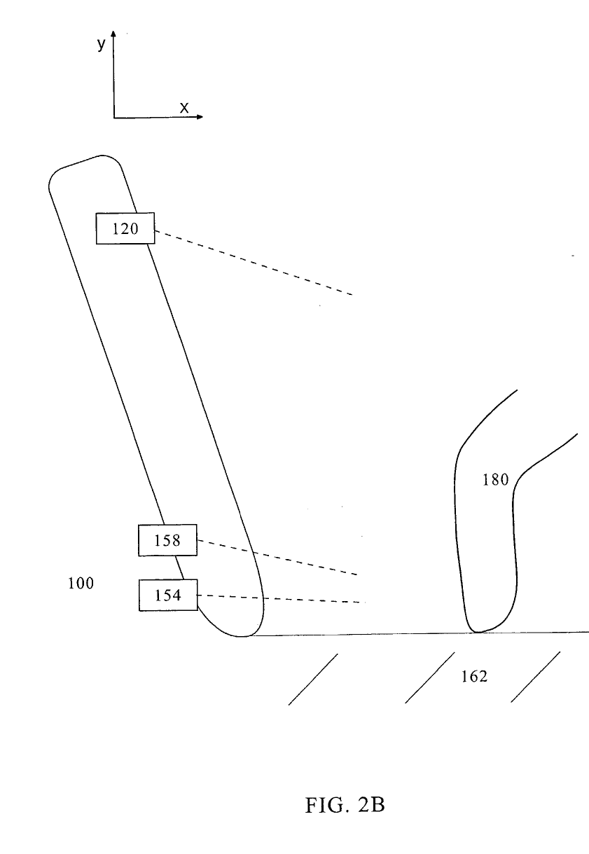

According to an embodiment, sensor system 150 is an optical type sensor. The sensor system 150 may include a transmitter that projects one or more beams of light from front face 102. The beams of light may be projected over active sensor area 168. The sensor system 150 may also include a light detecting device, such as a sensor 158 (See FIG. 2A), which detects light reflecting off of the object when the object intersects with the beams of light provided by the transmitter. Processing resources with the handheld computer (or otherwise associated with the sensor system 150) uses light detected by the sensor 158 to approximate a position of the object in the active sensor area 168. The processing resources may also determine an input value for the object being placed onto a specific region of the sensing area.

According to an embodiment, the light-generated input interface, which in FIG. 1 is represented by keyboard 124, is provided only within the active sensor area 168. Furthermore, various features and enhancements described below may be implemented to maximize the size and operability of the keyboard 124 (or other projected input device).

C. Component Configurations for Use With Interface

FIG. 2A is a top view illustrating an area where a light-generated input interface may be provided relative to an electronic device, under an embodiment of the invention. As described with FIG. 1, the input interface is shown by FIG. 2A to be an image of a keyboard.

In an embodiment such as shown by FIG. 2A, components for creating the input interface include projector 120 and sub-components of sensor system 150 (FIG. 1). The sensor system 150 includes an infrared (IR) source module 154 and a sensor 158. In one embodiment, sensor 158 may be a light detecting device, such as a camera. As previously explained, the sensor system 150 (FIG. 1) operates by directing one or more beams of IR light projected from IR source module 154 over the surface 162. The sensor 158 captures a reflection pattern forming on an object intersecting the beams directed by the IR module 154. Characteristics of the light pattern are processed to approximate the position of the object on the active sensor area 168 (FIG. 1). In one embodiment, sensor 158 may employ a super-wide angle lens on the sensor system to maximize the width of the sensing area at close proximity.

FIG. 2A illustrates the projector 120, IR module 154, and sensor 158 dispersed relative to an axis Z, which is assumed to be orthogonal to the lengthwise axis Y shown in FIG. 1. In the example provided by FIG. 1, the axis Z may correspond to a thickness of the handheld computer 100. The sub-components of sensor system 150 are not necessarily co-linear along either of the axes Z or Y. Rather, the axes are shown to provide a reference frame for descriptions that rely on approximate or relative positions.

In one embodiment, the projector 120, IR module 154, and sensor 158 each are operable for specific regions of surface 162. The keyboard 124 is provided within an intersection of these regions. Furthermore, embodiments described herein maximize the utility and size of the keyboard 124 within that designated area.

In an embodiment such as shown by FIG. 2A, a first area corresponds to a span of the light directed from IR module 154. The first area may be defined by curves 201, 201. A second area corresponds to a viewing area for the sensor 158. The viewing area may be defined by curves 203, 203. An intersection of the first and second areas may correspond to the active sensor area. The active sensor area may also be limited in depth, as one or more components of the sensor system 150 may have a limited range. A third area corresponds to the projection area of projector 120. The projection area is where a suitable image for an input device can be formed. The third area may be defined by curves 205, 205. Variations may exist in how projector 120 may be mounted into the housing of a device. Some accounting for different tolerances may be needed in determining the projection area. The lines 206, 206 illustrate an effective boundary for the span of the projector 120 when a tolerance for different implementations is considered.

According to one embodiment, an intersection area 212 is formed where the first area, second area, and third area intersect on the surface 162. The intersection area 212 corresponds to usable space on surface 162 where a light-generated input interface can be provided. The intersection area 212 may be tapered, so that its width increases as a function of distance from the device. The boundaries of the intersection area 212 may correspond to the most narrow combination of individual boundary lines provided by one of (i) the light directed from IR module 154, (ii) the sensor view of sensor 158, or (iii) the visible light directed from the projector 120. The particular boundary lines forming the overall boundary of the intersection area 212 at a particular point may vary with depth as measured from the device.

According to embodiments described herein, the intersection area 212 may be used to position a keyboard of a specified dimension(s) as close to the device as possible. Alternatively, the size of shape of the keyboard may be altered to able to fit the keyboard entirely within the intersection region 212 at a particular depth. For example, the keyboard may be tapered, or its width stretched so that some or all of the keys of the keyboard have maximum size within the allotted space of the intersection area at the given depth from the device. These principles may be applied to any displayed input interface having visually identifiable input areas.

In one implementation, keyboard 124 is configured to be substantially full-sized. To maximize usability, it is also desirable for keyboard 124 to appear as close to the device as possible so that the user may use the electronic device, for instance, on an airplane tray table.

Dimensions of keyboard 124 are determined, at least in part, by the dimensions of the intersection area 212. For many applications, larger sized keyboards are preferred. Accordingly, keyboard 124 is provided dimensions in width (along axis X) and in depth (along axis Z) that are maximized given an overall size of the intersection area 212. In particular, the width of the intersection area 212, as measured between individual boundary lines of the intersection area 212 at a particular depth from the device, may form the basis for determining the dimension of the keyboard 124.

One way to set the dimension of the keyboard 124 is to base the width on a desired or given depth between the keyboard 124 and the device. If the depth is assumed given, then the keyboard 124 can be made to fit in the intersection area 212 based on the required depth. The keyboard 124 can be made to fit within the area of intersection based on one or both of a width dimension and depth dimension for the keyboard being variable. For example, a dimension of the keyboard 124 along the axis Z may be fixed, while a dimension of the keyboard along the axis X is determined. The dimension along axis X is approximately equal to or slightly less than the width allowable on the intersection area 212 at the specified depth. The determined dimension of keyboard 124 along axis X may be based on the maximum width of the keyboard 124.

In one embodiment, keyboard 124 is provided so that top edge of the keyboard is aligned to extend depth-wise from a position corresponding to the specified depth. The depth-wise dimension of the keyboard 124 may be set with respect to the keyboard's width-wise dimension, so that the maximum width of the keyboard may be based on the available width of the intersection area 212, given the starting point of the keyboard 124. In FIG. 2A, the maximum width of keyboard 124 is illustrated by line 242, which intersects each of the boundaries of the intersection area 212 at points A, A. The starting point of the keyboard 124 is illustrated by line 244, which intersects each of the boundaries of the intersection area 212 at points B, B. From the starting point, the keyboard 124 is to extend depth-wise. If the dimension D in FIG. 2A is specified, then the overall width of the keyboard 124 may be determined by making the maximum width of the keyboard on line 242 fit within the boundaries of the intersection area 212 at line 244. Alternatively, the maximum width of the keyboard 124 can be moved closer to line 244, or provided on line 244, by making keys that appear above the row having the maximum width more conical in shape. For example, the three rows provided above line 242 in FIG. 2A may actually be split up into five more narrow rows. The maximum width represented by line 242 may then be converged towards the line 244.

In one embodiment, the depth of the keyboard from the device is fixed based on a range of sensor system 150. If any portion of the sensor system 150 extends out of range, the sensor system may not be able to reliably detect placement of the object. For example, the specified depth of the keyboard may be set by the operating ranges of the IR module 154 and/or the sensor 158. Alternatively, the maximum depth maybe set by a distance at which point the image provided by projector 120 becomes too grainy or faint. Still further, the depth of the keyboard 124 may be set as a design parameter, because an application for the light-generated interface dictates that a certain proximity between keyboard 124 and the housing of the electronic device is desired.

Another way to set the dimension of the keyboard 124 based on the size of the intersection area 212 is to set one or both of the keyboard's width or depth to be constant. Then, the intersection area 212 determines the location of the keyboard 124 relative to the device. Specifically, a distance D between a reference point of the keyboard 124 and the device may be determined by the set dimensions of the keyboard 124. The dimensions of the keyboard 124 may be valid as long as certain constraints of the keyboard's position are not violated. For example, the keyboard cannot be extended past a point where the sensor lose effectiveness in order accommodate the set dimensions of the keyboard 124. Thus, the dimensions of the keyboard 124 may be set to be optimal in size, but the location of the keyboard may be based on the dimensions of the intersection area 212.

With embodiments described with FIG. 2A, an overall dimension of the keyboard 124 may be set to be of a desired or maximum size, while ensuring that the keyboard will be provided on a region that is within a range of the sensing and projecting capabilities of the light-generated input interface. While embodiments of FIG. 2A are described in the context of a keyboard, other embodiments may similarly dimension and position other types of light-generated input interfaces. For example, a mouse pad region for detecting movement of the object ton surface 162 may be provided within the confines of the intersection area 212, and perhaps as a part of the keyboard 124. As another alternative, another type of punch pad, such as one including number keys or application keys, may be used instead of keyboard 124.

FIG. 2B is a side view of components for use in creating a light-generated input interface, where the components are incorporated into handheld computer 100. FIG. 2B is illustrative of how components for creating a light-generated input interface can be placed relative to one another. While FIG. 2B illustrates these components integrated into handheld computer 100, an embodiment such a described may equally be applicable to other types of electronic devices. Furthermore, components for creating a light-generated input interface may also be connected as an external apparatus to the electronic device receiving the input, such as through use of a peripheral port on a handheld computer.

In FIG. 2B, handheld computer 100 is aligned at a tilted, vertical angle with respect to surface 162. The components of a light-generated input interface include projector 120, IR module 154, and sensor 158. A usable area is provided on surface 162, where keyboard 124, or another type of light-generated input interface may be displayed.

In an application such as shown by FIG. 2B, each component may be configured to have a certain area on the surface 162. The area utilized by each of the components is determined by a fan angle and a downward angle. The fan angle refers to the angle formed about the X and Z (into the paper) axes. The downward angle refers to the angle formed about the X and Y axes. An operable area where the light-generated input interface may be displayed and operated may correspond to the intersection area 212 (FIG. 2A), where each of the areas formed by the components intersect on surface 162. An object 180, such as a finger, may select input from the light-generated input interface displayed on the intersection area 212.

In one embodiment, the fan angle of the projector 120 is about 60 degrees and the downward angle is between 30-40 degrees. The fan angle of the IR module 154 is about 90 degrees, with a downward angle of about 7.5 degrees. The sensor 158 may have a viewing angle of 110 degrees. An embodiment such as described in this paragraph is operable in the application of a standard size handheld computer 100, where the projector is formed above the display 105, and the sensor system 150 is provided below the display. Such an application is illustrated in FIG. 1.

D. Key Design Considerations for Light-Generated Keyboard

A light-generated input interface may provide identifiable regions that identify different input values by delineating and/or marking each of the identifiable regions. Different considerations may exist for delineating and/or marking identifiable regions in a particular way or manner.

(1) Key Shading & Marking

According to one embodiment, shading is used to make clear delineations of the keys in the input mechanism. The purpose of the delineations may be to enhance the visibility and appearance of the keys. Since the keys are really only images, a clearly identifiable key having three-dimensional aspects may detract from other limitations, such as graininess or blurriness of the image.

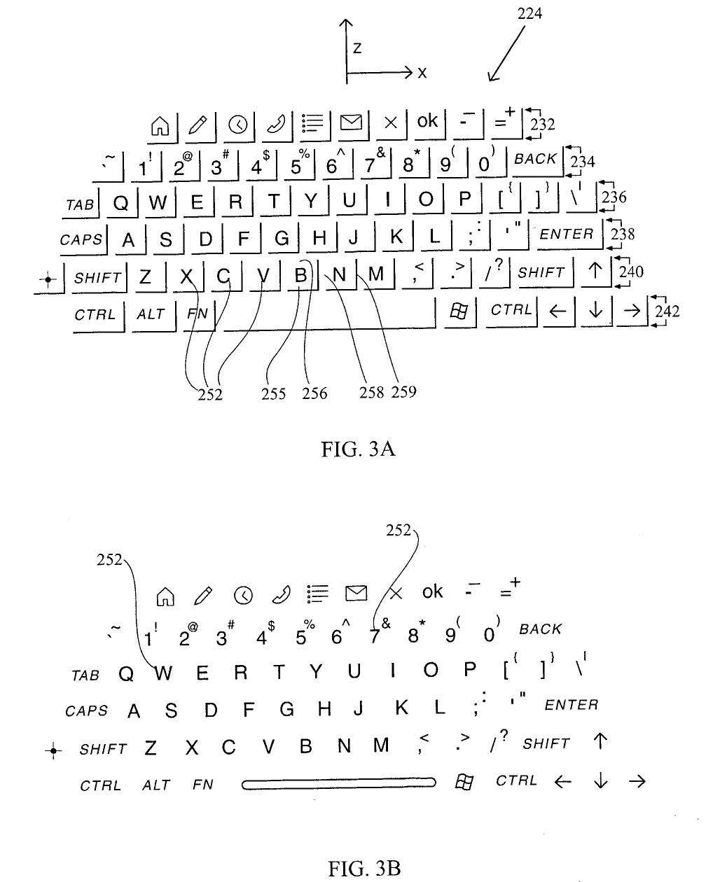

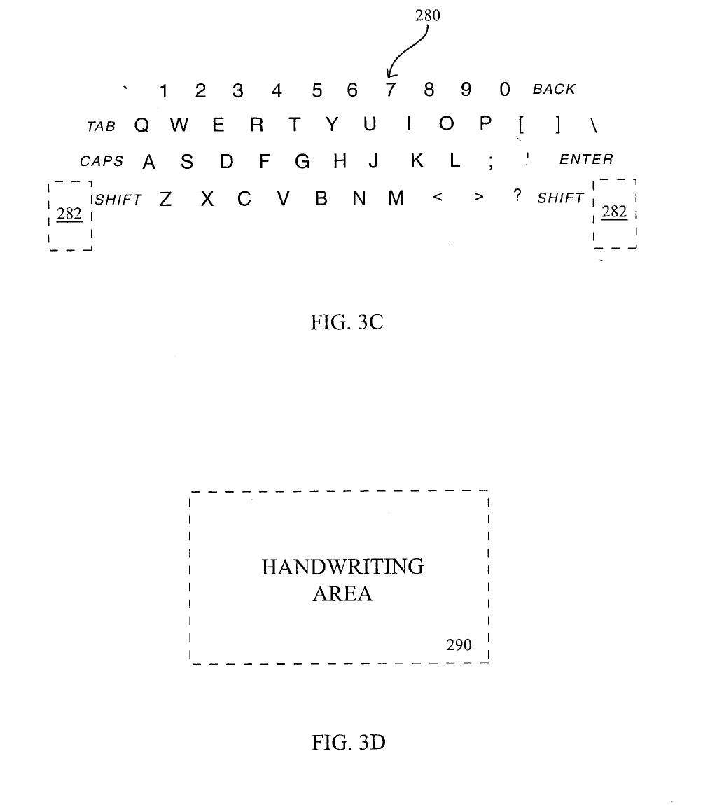

In one embodiment illustrated by FIG. 3A, keys of a light-generated input interface are provided a partial border that gives the keys a more three-dimensional appearance. The keyboard 224 may be in a QWERTY form. A first row 232 of keyboard 224 may provide function keys for causing a device receiving input from the keyboard 124 to perform a designated function. A second row 234 may provide number keys and special characters in a shift-mode. A third row, 236, fourth row 238, fifth row 240 and sixth row 242 may follow the standard QWERTY key design.

The keyboard 224 may be described with reference to the X and Z axes. Each key delineates a region on surface 162 (FIG. 1) that is distinctly identifiable by sensor system 150. The marking on each key indicates to a user that contact with surface 162 at the region identified by a particular key will have an input value indicated by the marking of that key.

In addition, each key 252 may be rectangular in shape, so as to have a top edge 255 and bottom edge 256 extending along the X-axis, and a left edge 258 and a right edge 259 extending along the Z-axis. In one embodiment, two sides to the border of each key 252 are thickened or darkened. The other two sides of the border to each key 252 may have relatively thinner or lighter lines, or alternatively not have any lines at all. The border configuration of each key 252 may be provided by the projector 120 (see FIG. 1 of the input mechanism). In an example provided by FIG. 3A, the bottom edge 255 and the right edge 259 of each key 252 has a thick boundary, and the top edge 256 and the left edge 258 has no boundary. The result is that there is an appearance that a source of light shines on the keyboard 224 from the bottom left corner, and the source of light reflects off of solidly formed keys, thereby creating the border pattern seen on the keys.

FIG. 3B illustrates an alternative embodiment where individual keys of the device displayed by the interface have no boundaries. Such an embodiment may be used to conserve energy and the life of projector 120 (FIG. 1). In FIG. 3B, each key 252 of keyboard 224 has only a marking, but no shading. Only the marking identifies a region that is distinctly identifiable to the sensor system 150 (FIG. 1). The marking of the key 252 identifies the value of the input key. An embodiment such as described with FIG. 3B may be implemented to conserve energy of the power source used by the components used. In addition, such an embodiment may enable the keyboard to be shrunk in its overall size, without requiring the individual keys 252 to be shrunk equally in size.

FIG. 3C illustrates keyboard 224 configured to provide a mouse pad region 282. The mouse pad region 282 provides a pointer and selection feature. The pointer feature is provided by enabling the user to enter a series of contacts, preferable a movement of an object from a first point to a second point, to simulate a mechanical mouse pad. The keyboard 224 may be separated into a letter portion 280 and one or more mouse pad regions 282. Each of the regions may be varied in size, based on design specifications.

FIG. 3D illustrates another layout, where the keyboard 224 is completely replaced with a handwriting area 290. The handwriting area 290 provides a visual indication of a usable space to the user. Motions on the usable space are tracked and entered as input. In one embodiment, the handwriting area 290 may be selectable by the user to temporarily replace keyboard 224. In one implementation, the handwriting area 290, combined with the processing resources and the sensor system 150 (FIG. 1), provides digital pen functionality. In another embodiment, the handwriting areas 290 provides handwriting recognition based on a sequence of one or more gestures being made onto the handwriting area 290.

(2) Layout Considerations

A layout of keyboard 224 may be designed in order to account for range limitations of sensor system 150. For example, if the reliability of sensor system 150 lessens with depth from the device, then the keyboard 224 may be configured by placing more commonly used keys closer to the sensor. In FIG. 3A for example, some or all of the keys the first row 232 may be switched in position with one or more keys in the sixth row 242. Particularly, the “space bar” in the sixth row 242 may be moved up to occupy a portion of the first row 232. For example, the length of the space bar may be changed to fit in a space occupied by two or three of the keys in the first row 232.

In another embodiment, the keys of keyboard 224 may be rearranged so that the alphanumeric keys remain in their normal place at the correct size (defined by ISO/IEC #9995) and modify the placement of only the non-alphanumeric keys and other sensing regions (e.g. mouse) so that they typing action remains the same as with a full sized keyboard. This results in a “projection-optimized standard keyboard design.” Under this method, keys that must remain in the same location as defined in ISO/IEC #9995 include: A, B, C, D, E, F, G, H, I, J, K, L, M, N, O, P, Q, R, S, T, U, V, W, X, Y, Z,“,”, “.”, /, ‘, ;, 1,2,3,4,5,6,7,8,9,0. Other keys that may be required to remain in the same position include: <spacebar>, =, and −. All other keys may be repositioned and re-sized. For example, keys that are non-frequently used (those other than what is defined above) may be changed in size to be non-standard so the size of the overall sensing region may be reduced. Space is saved in the overall sensing and projection area by reducing these non-critical keys and usability is retained by keeping the key spacing and size of the frequently used keys.

(3) Object Occlusions Affecting Key Selection

When keyboard 224 is implemented through light, it is desirable to enable the keyboard to be operated in a manner that is most similar to standard mechanical keyboard design. To this end, standard keyboards enable use of two-key combinations, such as provided through use of “Shift”, “Control” and “Alt”. However, in the context of light-generated keyboard 224, the two-key combinations as implemented in mechanical embodiments may not be sufficiently reliable because the selection of one key blocks the sensor system 150 from detecting the selection of the second key in the two-key combination. For example, selection of “Shift” and “A” may result in the input value being detected as “a” and not “A” because the selection of the “A” key blocks the selection of the “Shift” key. Absent considerations such as described below, the conclusion drawn by the processing resources may be that the “Shift” key was unselected when “A” was selected.

One solution to this problem is to alter the layout of the keyboard 224 so that no key used in two-key combinations can be blocked by the selection of another key. For example, the “Shift”, “CTRL” and “ALT” keys may be moved sideways away from the alphabet letters. Alternately, a modifier key (e.g. Shift) may be positioned to be precluded from being able to obscure the key being modified (e.g. “A”) and minimize the number of modifier keys themselves being obscured by other keys.

Another solution to this problem is to require keys requiring two-key combinations (i.e. “Shift”, “CTRL” and “ALT” keys) to be unselected only through a second contact by the object unto the region defined by those keys. Thus, a “Shift” key will remain in operation until it is unselected again.

Still further, another alternative is to assume that selection of the “Shift” key (or the other two-key combination keys) applies to only the very next key selected. A double-selection of the “Shift” key may be interpreted as a selection to apply that key to all subsequent key selections until the “Shift” key is re-selected.

Conversely, the use of multiplex keys can conserve the overall space of the keyboard 224. In such an embodiment, certain key functions (such as the arrow keys) may share a single physical region of the keyboard layout with another key. For instance, an additional key may be implemented in a non-critical geometrical area of the keyboard layout (e.g. near the bottom of the keyboard) to change certain alphanumeric keys (e.g. I, J, K, L) into arrow keys.

Additionally, a key can be used to switch to a different keyboard layout with differently sized keys containing different functionality such as mouse regions. This layout switch can either switch the layouts while it is held down and switch back to the original layout when it is released (similar to shift key functionality) or it can switch back and forth between layouts during subsequent key presses (similar to caps lock functionality).

The temporary layout switch key (similar to shift functionality) which switches from a primary to a secondary layout should be placed close to the sensor to ensure stability of the detection while the region is pressed. It should also be placed such that it is not obstructed by a finger descending or sliding in other key regions between itself and the sensor while the secondary layout is active. The temporary switch key must not coincide or overlap with a region of different purpose on the secondary layout

The permanent switch key (similar to caps lock functionality), which switches back and forth between one or more layouts through subsequent key presses, should be placed such that it is not accidentally pressed during normal operation. To signal the change in layout after the key is pressed, visual queues such as a change in the projection, a dimming of the projection on-screen indicators or an auditory signal can be used.

(4) Iconic Keys

As illustrated by first row 232 (FIG. 3A), keyboard 224 may implemented iconic keys. Iconic keys refer to keys that are marked by illustrations. Often, iconic keys are set by third-party manufacturers and/or industry practice. For example, computers operating WINDOWS OS (manufactured by MICROSOFT CORP.) operating system often have keyboards with a WINDOWS icon appearing on it for specific operations of the operating system. Selection of iconic keys often corresponds to an input for performing an operation that is more complex than simply entering an alphanumeric character. For example, selection of an iconic key may launch an application, or cause the device receiving the input to reduce its power state.

In the context of light-generated keyboard 224, iconic keys may require disproportionate amount of light in order to be displayed. As a result, iconic keys can consume too much power. \ In particular, sharp or detailed aspects of an icon may be removed or blurred, as such aspects require a high amount of resolution when compared to other keys. In addition, fill regions in icons are not filled when displayed through light, but rather outlined.

(5) Other Considerations for Reducing Power Consumption

An overall power consumed in providing the light-generated keyboard 224 may be reduced considerably by implementing some or all of the following features. The thickness of the fonts appearing on the keys 252 may be reduced, thereby reducing the overall light required by each key. A minimum thickness of the fonts should be sufficient so that the projected power can be seen. The minimum thickness of the fonts may be such that a width of any feature of a marking on one of the keys 252 is less than 2.0 mm, and preferably about 1.5 mm.

Grayscale imagery may be used to reduce the number of diffractive orders and brightness required to create the markings. In one embodiment, only some of the features of keyboard 124 may be provided using grayscale imagery. For example, lines demarcating the keys, as shown by FIG. 3A, may be provided in grayscale, while the markings on the keys are provided using full brightness. The grayscale may also be used to create the markings of the less-important keys.

In another embodiment, any feature (including lines demarcating the keys) may be rendered as a series of visible dots. A user may see the sequence of dots as a dotted-line, a gray line, or even a dim line. If the dots are aligned sufficiently close to one another, the marking of the particular key 252 may be communicated to the user while reducing the overall power consumed in creating the keyboard 224.

Another way to reduce the optical power in the outline is to reduce its extent of the outline. FIG. 3A shows how an effective trompe d'oeil can be created for the keyboard 224. The lines delineating the keys are only partially instantiated but still communicate the location of the individual keys. Similarly other features of the keyboard may be removed if they can be effectively inferred by the operator.

(6) Configuring Sensor Detection to Accommodate Key Layout

The typing action that can be detected by sensor system 150 may be configured to facilitate the display of keyboard 224 (FIG. 3A). In one embodiment, for each distinct key or region identified by keyboard 224, a conceptual sensing region is created for use with sensor system 150. Specifically, for each key or layout region, the size and geometry of the sensing region is defined differently than the optical region, depending on user behavior. For instance, a keystroke may only be registered if the user strikes the area in the middle (and smaller) of the image of the key. In situations such as shown by FIG. 3A, where adjacent keys are not abutting one another, the user is encouraged to hit each individual key at its center. This reduces ambiguity that otherwise arises when fingers strike close to the boundary of the two keys by creating a visual dead zone between keys.

(7) Dynamic Ability to Alter Image of Interface

An embodiment of the invention enables for the light-generated input interface to be selectable and dynamic. Specifically, a user may make a selection to alter one input interface for another. The selection may cause, for example, projector 120 to switch from displaying a keyboard shown in FGI. 3A with a handwriting recognition area shown in FIG. 3D. The change in selection may be carried through so that information obtained from sensor system 150 will correctly reflect the new configuration of the keyboard or other interface being shown.

In addition, it is possible to maintain one type of interface in the image shown, but to dynamically alter the image of that particular interface. For example, the keyboard 224 may be made larger to accommodate a bigger environment. The selection may be made by the user. Alternatively, the selection may be made automatically by a processor or other mechanism using information obtained through user-input, the sensor system 150, or alternative means. Other examples of the types of changes that can be made include making some or all of the keys bigger, including a mouse pad region with a keyboard on selection by a user, altering the function keys presented, and changing the image of the interface into gray scale. When necessary, processing resources and the sensor system 150 may be reconfigured to recognize the new attributes of the displayed interface.

E. Fitting Light-Generated Interface Within Intersection Area

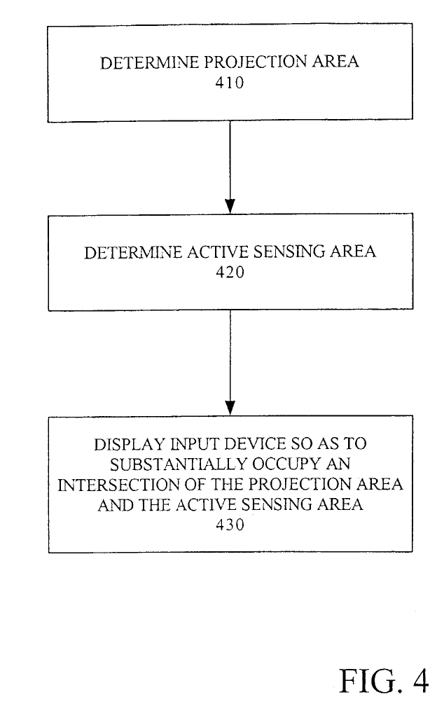

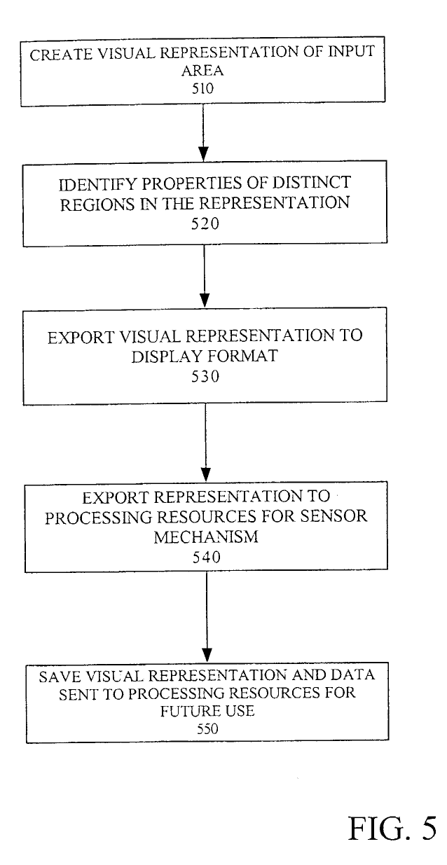

The components of a light-generated input interface may be distributed on different electronic devices, each of which have different sizes and form factors. In order to maximize the dimensions and/or usability of the light-generated input interface for each application, the area in which the interface is to operate may need to be determined. FIG. 4 illustrates a method for determining the operable area for where a light-generated input interface can be displayed. A method such as described may be applicable to any device incorporating a light-generated input interface. However, for purpose of description, reference is made to a handheld computer and to elements of FIG. 1, FIG. 2A and FIG. 2B.

In step 410, a projection area is determined for projector 120. The projection area corresponds to an area on surface 162 that the projector can illuminate. The projection area may be determined by the fan angle and the downward angle of the projector 120. Other dimensions that can be used to determine the projection area include the distance of the projector 120 from the surface 162. This distance may be determined based on the tilt of the handheld computer 100 resting on the surface 162 at the time the projection is made.

Step 420 provides that an active sensing area is determined. The active sensing area corresponds to an area on surface 162 where sensor system 150 can reliably detect the position of an object making contact with the surface. In one embodiment such as described with FIGS. 2A and 2B, sensor system 150 includes IR module 154 and sensor 158. The active sensing area may comprise the intersection of the projection area for light directed from IR module 154, and the viewing angle of sensor 158. The projection area for light directed from IR module 154 may be determined from the downward angle of a transmitter of the IR module 154, and the fan angle of that transmitted. The viewing angle of the sensor 158 may be determined by the sensor lens.

In step 430, the light-generated input interface is displayed to substantially occupy, in at least one dimension, an intersection of the projection area and the active sensing area. As used herein, the term “substantially” means at least 80% of a stated item. Thus, one embodiment provides that the light-generated input interface is displayed so as to occupy at least 80% of the maximum width of the intersection area 212.

In one embodiment, a method such as described by FIG. 4 is performed during manufacturing of an electronic device incorporating a light-generated input interface. In another embodiment, a method such as described by FIG. 4 is performed by an electronic device that incorporates a light-generated input interface. In such an embodiment, the electronic device may perform the method in order to configure the interface and its image for a particular environment. For example, the electronic device may employ one configuration for when keyboard 124 is selected to be enlarged, and another configuration for when the size of keyboard 124 is selected to be reduced. The first configuration may be for an environment such as a desk, while the second configuration may be for a more cramped working environment, such as on an airplane tray.

F. Customizing Light-Generated Input Interface

An embodiment of the invention enables for light-generated input interfaces to be customized. Specifically, an input interface such as described may customize different portions of an input interface based on a specified type of contact that the portion of the interface is to accept, an appearance that the portion of the interface is to have, and other properties that are to be associated with presentation or actuation of that portion of the interface.

FIG. 5 illustrates a method for customizing a light-generated input interface for use with an electronic device. In step 510, a visual representation of the interface is created. The visual representation may be created using standard graphics software. Examples of such software include VISIO, manufactured by MICROSOFT CORP., and ADOBE ILLUSTRATOR, manufactured by ADOBE INC. The visual interface indicates the arrangement and positioning of distinct regions of the input interface, as well as the markings for each individual region of the interface. For example, the visual representation may be of a keyboard, such as shown in FIG. 3A.

In step 520, properties of the distinct regions identified in the visual representation are specified. The type of properties that can be specified for a particular region include a designation of a particular region as being active or inactive, a function type of the particular region, and the relative sensitivity of the particular region. In one embodiment, the function type identified for each region of the interface may be one or more of the following: (i) a mouse region where a user can use a pointer to trace a locus of points on the identified region in order to indicate position information, and where the user can enter selections using the pointer at a particular position; (ii) a key that can be actuated to enter a key value by a user making a single contact with the surface where the identified region of the key is provided; (iii) a multi-tap region where a user can enter input by double-tapping a surface where the multi-tap region is provided; (iv) a stylus positioning element which visually indicates where a user can move an object to simulate a stylus in order to trace a locus over the particular region; and (v) user-defined regions which allow the user to create specific types of regions that the users will interpret them by their own algorithms.

In an embodiment, each region may be identified with auditory features, such as whether user-activity in the particular region is to have an auditory characteristic. For example, regions that correspond to keys of a keyboard may be set to make a tapping noise when those keys are selected by the user through contact with a surface where the keys are provided.

Other function types for a particular region may specify whether that region can be used simultaneously with another region. For example, a region correspond to the “Shift” key may be specified as being an example of a key that can be selected concurrently with another key.

Still further, another embodiment provides that a region may be specified as a switch that can be actuated to cause a new light-generated interface structure to appear instead of a previous interface structure. For example, a first structure may be a number pad, and one of the regions may be identified as a toggle-switch, the actuation of which causes a keyboard to appear to replace the number pad.

Step 530 provides that the visual representation of the interface is exported into a display format. The display format may correspond to a binary form that can be utilized by a printer or display. For example, a bitmap file may be created as a result of the conversion.

In step 540, the visual representation of the interface is exported to the processing resources used with the sensor system 150 (FIG. 1). The processing resources identify, for example, positioning of an object over the interface, and correlate the positioning to a particular value dictated by the function type assigned to the identified position of the object. In one embodiment, the visual representation is exported into a machine-readable format that contains the overall representation and function types. The machine-readable format may correspond to code that can be executed by the processing resources of the sensor system 150 (FIG. 1). Once executed, each region of the light-generated interface may be assigned to a particular function type and value.

In step 550, both the visual representation and the machine-readable code may be saved so that the particular interface designed by the user can be created and subsequently used. In addition, the visual representation and code may be saved in order to permit subsequent modifications and changes.

In one embodiment, calibration regions of the input interface may be identified to streamline the alignment of the visual display with the treatment of the individual regions by the sensor system 150. For example, one or more keys on keyboard 124 may act as calibration regions which ensure that the sensor system 150 is correctly understanding the individual keys that form the overall keyboard.

As an example, a desired interface may be in the form of a keypad. For each region that corresponds to a key in the keypad, a user may specify the status of the particular region (active or inactive), the function type of the region (key), the sensitivity of the region to contact (low), and whether selection of the region should carry an audible simulating the selection of a mechanical key.

An embodiment such as described in FIG. 5 may be implemented in a tool that is either internal or external to the device where the light-generated interface is created.

G. Projection Correction

In an embodiment such as shown in FIG. 1, projector 120 comprises a light source and a DOE. The light source may correspond to a laser that is configured to direct structured light through the DOE, so that the structured light exits the DOE in the form of predetermined images of input interfaces and devices. Initially, the laser directs light through the DOE in a manner that can be described using Cartesian coordinates. But the DOE casts the light downward and the light scatters on the surface such that the resulting light projection loses its Cartesian aspect. In order to create an image, the Cartesian reference frame is combined with a mapping function. The image desired is first characterized in the Cartesian reference as if the light used to create the image can exit the DOE without losing any of its Cartesian attributes. Then the Cartesian reference frame used to create the desired image is mapped to account for the loss of the Cartesian aspects once the structured light hits the surface.

Traditionally, the mapping of the image from the Cartesian form into one that is skewed to account for changes that occur with the bending and scattering of light is highly-error prone. The resulting images are often grainy, and the rendition of the markings and icons are poor. Current applications provide that a text-file is output which indicates on a coordinate by coordinate basis, whether a particular pixel point on the surface where the image is cast is lit or unlit. In the past, the text file has been used to correct for the errors in the resulting image. But use of the text-file in this manner is often labor-intensive.

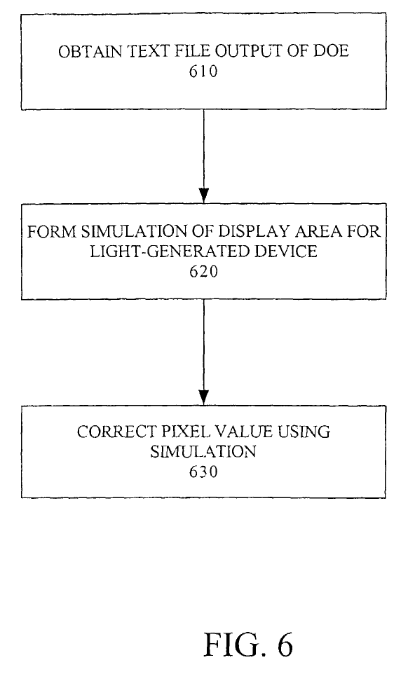

FIG. 6 illustrates a method by which the output image of the DOE can be corrected for errors that result from the bending and scattering of the structured light that passes through the DOE and on onto a surface where the interface is to be displayed.

In step 610, the text-file output of a predetermined image is obtained for a particular DOE. In the text-file, the DOE makes a first prediction as to how the image is to appear in the output. The output may be in the form:

<x-coordinate value>, <y-coordinate value><pixel space value>

The pixel space value is a binary value corresponding to whether the particular coordinate is lit or unlit.

In step 620, a simulation of the display space is formed on a computer-generated display. For example, the simulation may be produced on a monitor. The simulation is based on the pixel space values at each of the coordinates in the text-file. The simulation enables a zoom feature to focus on sets of pixels in discrete portions of the interface that is being imaged. FIG. 7 illustrates one region where the “delete” key may be provided. In this step, the image is grainy, as no correction has yet taken place.

In step 630, selections are made to reverse incorrect pixel values. In one embodiment, this is done manually. A user may, for example, use a mouse to select incorrect pixels that are displayed on the monitor. A selected pixel may reverse its value. Thus, an unlit pixel may become lit when selected, and a lit pixel may become unlit after selection. The selections may be made based on the judgement of the user, who is viewing the simulation to determine incorrect pixels.

Alternatively, step 630 can be performed through automation. The image in step 620 may be compared, on a pixel-by-pixel basis, with a desired picture of what the interface is to look like when cast on the surface. A software tool, for example, may make the comparison and then make the selection of pixels in an automated fashion.

While an embodiment such as described in FIG. 6 describes use of an output file from the DOE, it is also possible to generate the equivalent of the output file independent of the DOE function. For example, a suitable output file may be generated through inspection of the image created by the DOE.

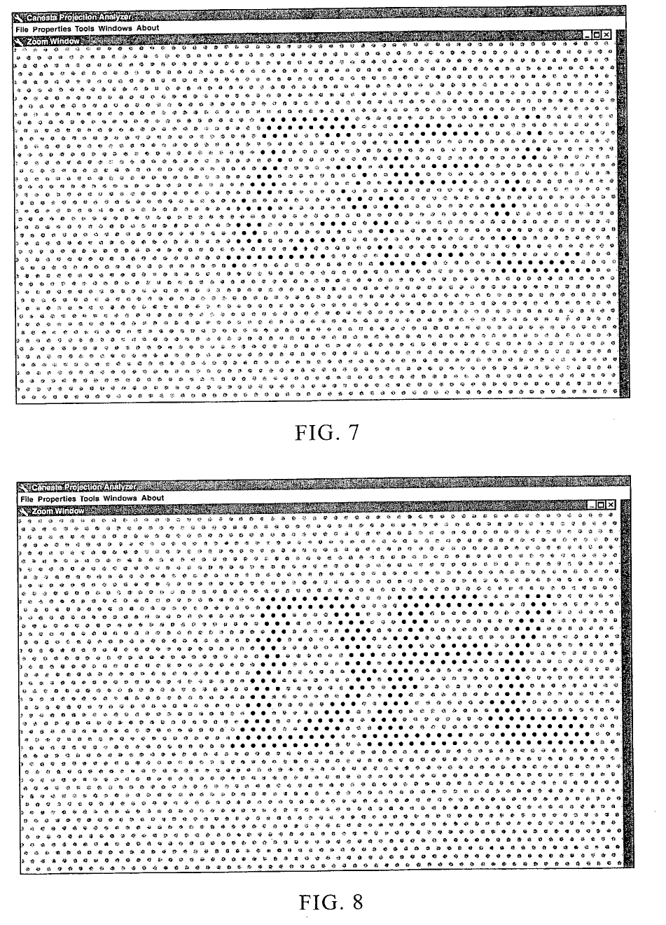

FIG. 8 illustrates the same portion of the “Delete” key after step 630 is performed. The result is that the image is made more clear and crisp.

H. Alternative Embodiments

While embodiments described above describe a projected image being provided for the input interface, it is possible for other embodiments to use images created on a tangible medium to present the input interface. For example, a board or other medium containing a printed image of a keyboard and other input areas may substitute for the projected image.

Concepts incorporated with embodiments of the invention are applicable to the printed image of the input device. Specifically, the size of the printed image may be determined based on the active sensor area. Alternatively, the size of the printed image may be given, and the position of the printed image may be dependent on where the active sensor area is large enough to accommodate the printed image.

Certain considerations described with embodiments above regarding the layout of the keyboard are also equally applicable to instances when the keyboard is fixed in a tangible medium. For example, the occlusion keys may be arranged so that the selection of one key does not prevent the sensor system from viewing the occlusion key.

Still further, other embodiments provide that no image is provided of the input interface. Rather, an area is designated as being the input area. The size and/or position of this area may be set to be accommodated within the active sensor area.

Embodiments of the invention may also be applied to sensor systems that operate using mediums other than light. For example, an input interface may correspond to a tablet upon which a device such as a keyboard may be projected. Underneath the tablet may be capacitive sensors which detect the user's touch. The position of the user's fingers may be translated into input based on a coordinate system shared by the projector which provides the image of the device. The size and/or position of the tablet would be dependent on the projection area. For example, the size of the tablet may be fixed, in which case the position of the tablet would depend on the depth at which the projection area can accommodate the all of the tablet. Alternatively, the position of the tablet may be a given, in which case the dimensions and shape of the tablet may be set to fit within the projection area at the given position.

I. Hardware Diagram

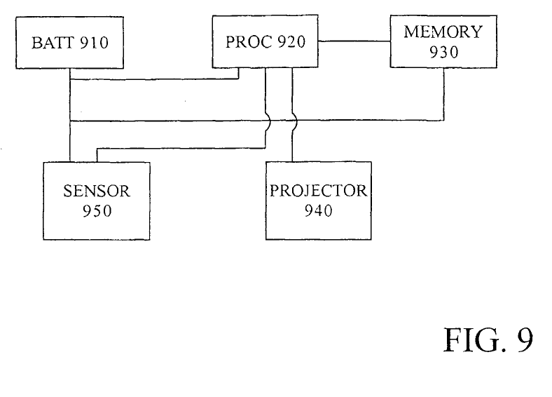

FIG. 9 illustrates a hardware diagram of an electronic device that incorporates an embodiment of the invention. An electronic device may include, either internally or through external connections, a battery 910, a processor 920, a memory 930, a projector 940 and a sensor 950. The battery 910 supplies power to other components of the electronic device. While the battery 910 is not required, it illustrates that a typical application for a light-generated input interface is with a portable device having its own power source.

The processor 920 may perform functions for providing and operating the light-generated input interface. The projector 940 projects an image of an input device onto an operation surface. The area where the input device is projected may be determined by the processor 920, as described with FIG. 4. The sensor 950 detects user-activity with the displayed input device by detecting placement and/or movement of objects on input regions that are displayed to the user as being part of a light-generated input device. The memory 930 and the processor 920 may combine to interpret the activity as input. In one embodiment, sensor 950 projects light over the area where the image of the input device is provided. The sensor 950 captures images of light reflecting off a user-controlled object intersecting the directed light of the sensor. The processor 920 uses the captured image to determine a position of the user-controlled object. The processor 920 also interprets the determined position of the user-controlled object as input.

F. Conclusion

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. An electronic input device comprising:
a sensor system capable of providing information for approximating a position of an object contacting a surface over an active sensing area; and
a projector capable of displaying an image onto a projection area on the surface, wherein the image indicates one or more input areas where placement of an object is to have a corresponding input; and
wherein at least one of the sensor system and the projector are oriented so that the image appears within an intersection of the active sensing area and the projection area.

2. The electronic input device of claim 1, further comprising:
a processor coupled to the sensor system, wherein in response to the object contacting the surface within any of the one or more input areas, the processor is configured to use the information provided from the sensor system to approximate the position of the object contacting the surface so that the input area contacted by the object can be identified.

3. The electronic input device of claim 1, wherein the sensor system comprises a sensor light to direct light over the surface, and a light detecting device to capture the directed light reflecting off of the object, wherein the sensor light directs light over a first area of the sensor and the light detecting device detects light over a second area of the surface, and wherein the active sensing area is formed by an intersection of the first area and the second area.

4. The electronic input device of claim 2, wherein the processor is configured to identify an input value from the identified input area contacted by the object.

5. The electronic input device of claim 3, wherein the light detecting device identifies a pattern captured from the light reflecting off the object, the pattern being measurable to indicate the approximate position of the object contacting the surface.

6. The electronic input device of claim 1, wherein the one or more input areas indicated by the image include a set of keys, and wherein each key corresponds to one of the input regions.

7. The electronic input device of claim 1, wherein the one or more input areas indicated by the image include a set of alphanumeric keys.

8. The electronic input device of claim 7, wherein the set of alphanumeric keys correspond to a QWERTY keyboard.

9. The electronic input device of claim 1, wherein the one or more input areas indicated by the image include one or more input areas corresponding to an interface that operates as one or more of a mouse pad region, handwriting recognition area, and a multi-directional pointer.

10. The electronic input device of claim 1, wherein the projector is configured to reconfigure the image to change the one or more input areas that are displayed.

11. An electronic input device comprising:
a sensor system capable of providing information for approximating a position of an object contacting a surface over an active sensing area; and
a projector capable of displaying a keyboard onto a projection area on the surface, wherein the keyboard indicates a plurality of keys where placement of an object is to have a corresponding input; and
wherein at least one of the sensor system and the projector are oriented so that the keyboard appears within an intersection of the active sensing area and the projection area.

12. The electronic input device of claim 11, further comprising:
a processor coupled to the sensor system, wherein in response to the object contacting the surface within any area designated by one of the plurality of keys, the processor uses the information to approximate the position of the object contacting the surface so that a selected key is determined from the plurality keys, the selected key corresponding to the area contacted by the object.

13. The electronic input device of claim 11, wherein the sensor system comprises a sensor light to direct light over the surface, and a light detecting device to capture the directed light reflecting off of the object, wherein the sensor light directs light over a first area of the sensor and the light detecting device detects light over a second area of the surface, and wherein the active sensing area is formed by an intersection of the first area and the second area.

14. The electronic input device of claim 12, wherein the processor identifies an input value from the selected key.

15. The electronic input device of claim 13, wherein the light detecting device identifies a pattern captured from the light reflecting off the object, the pattern being measurable to indicate the approximate position of the object contacting the surface at the selected key.

16. The electronic input device of claim 11, wherein the keyboard is a QWERTY keyboard.

17. The electronic input device of claim 11, wherein the projector delineates individual keys in the plurality of keys by shading at least a portion of each of the individual keys.

18. The electronic device of claim 11, wherein the projector delineates individual keys in the plurality of keys by shading only a portion of a border for each of the individual keys.

19. The electronic device of claim 18, wherein the projector shades the portion of the border for each of the individual keys forming the keyboard along a common orientation.

20. The electronic device of claim 11, wherein a position where the keyboard is displayed is based on a designated dimension of the keyboard, wherein the position is determined by a region of the intersection area that is closest to the sensor system and can still accommodate the size of the keyboard.

21. The electronic device of claim 11, wherein a size of the keyboard is based on a designated position of the keyboard, wherein the size of the keyboard is based at least in part on a width of the keyboard fitting within the intersection area at the position where the keyboard is to be displayed.

22. The electronic device of claim 21, wherein a depth-wise dimension of the keyboard is designated, and wherein a width of the keyboard is approximately a maximum that can fit within the intersection area at the position where the keyboard is to be displayed.

23. The electronic device of claim 22, wherein a shape of the keyboard is conical.

24. The electronic device of claim 22, wherein a shape of the keyboard is conical so that a maximum width-wise dimension of the keyboard is at least 75% of a width-wise dimension of the intersection area at a depth where the maximum width-wise dimension of the keyboard occurs.

25. The electronic device of claim 22, wherein a shape of the keyboard is conical so that a maximum width-wise dimension of the keyboard is at least 90% of a width-wise dimension of the intersection area at a depth where the maximum width-wise dimension of the keyboard occurs.

26. The electronic device of claim 11, wherein the projector delineates individual keys in the plurality of keys by shading at least a portion of each of the individual keys, and wherein at least a first key in the plurality of the keys is delineated from one or more other keys adjacent to that key by a projected dotted lines.

27. The electronic device of claim 16, wherein a set of keys having individual keys that are not marked as being one of the alphabet characters are positioned furthest away from the sensor system along a depth-wise direction.

28. The electronic device of claim 11, wherein the projector projects at least some of the keyboard using a gray scale light medium.

29. The electronic device of claim 11, wherein the plurality of keys include one or more occlusion keys that can form two-key combinations with other keys in the plurality of keys, and wherein the plurality of keys are arranged so that the selection of anyone of the other keys does not preclude the sensor system from detecting that one of the one or more occlusion keys is concurrently selected.

30. The electronic input device of claim 12, wherein the projector displays a region along with the keyboard, the region being designated for the sensor system to detect a placement and movement of an object within the region.

31. The electronic device of claim 30, wherein the processor interprets a movement of the object from a first position within the region to a second position within the region as an input.

32. A method for providing an input interface for an electronic device, the method comprising:
identifying a projection area of a projector on a surface, the projection area corresponding to where an image provided by the projector of an input interface with one or more input areas can be displayed;
identifying an active sensor area of a sensor system on the surface, the sensor system being in a cooperative relationship with the projector, the active sensor area corresponding to where a sensor system is capable of providing information for approximating a position of an object contacting the surface; and
causing the image of the interface to be provided within a boundary of an intersection of the projection area and the active sensor area.

33. The method of claim 32, further comprising:
approximating a position of an object contacting one of regions of the interface using information provided from the sensor system.

34. The method of claim 32, further comprising:
projecting a keyboard using the projector on the intersection of the active sensor area and the projection area; and
determining a key in the keyboard selected by a user-controlled object contacting the surface by approximating a position of the object contacting one of the regions of the keyboard using information provided from the sensor system.

35. The method of claim 34, wherein identifying an active sensor area of a sensor system on the surface includes identifying a first area on the surface where a sensor light of the sensor system can be directed, and identifying a second area where a light detecting device of the sensor system is operable, wherein the active sensor area corresponds to an intersection of the first area and the second area.

36. The method of claim 33, wherein causing the image of the interface to be provided within a boundary of an intersection of the projection area and the active sensor area includes fitting the image of the interface into the intersection area at a given depth from the electronic device.

37. The method of claim 36, wherein fitting the image of the interface into the intersection area at a given depth from the electronic device includes determining a maximum dimension of the interface based on a span of the intersection area in a region of the intersection area that is to provide the input interface.

38. The method of claim 36, fitting the image of the interface into the intersection area at a given depth from the electronic device includes tapering a shape of the input interface based on a span of the intersection area in a region of the intersection area that is to provide the input interface.

39. The method of claim 36, wherein causing the image of the interface to be provided within a boundary of an intersection of the projection area and the active sensor area includes positioning the input interface within a region of the intersection that can accommodate a designated size of the input interface.

40. A method for providing a light-generated input interface, the method comprising:
converting a representation of a specified configuration for the light-generated input interface into a first form for use by a projector;
converting the representation of the configuration for the light-generated input interface into a second form for use by a sensor system; and
causing the light-generated input interface to be projected onto a surface to have the specified configuration of the representation.

41. The method of claim 40, wherein converting a representation of a specified configuration includes receiving a computerized illustration of the specified configuration.

42. The method of claim 40, wherein converting a representation of a specified configuration for the light-generated input interface into a first form for use by a projector includes converting the representation into a bitmap file, and wherein the method further comprises converting the projector using the bitmap file.

43. The method of claim 40, wherein converting the representation of the configuration for the light-generated input interface into a second form for use by a sensor system includes converting the representation into a set of machine-readable configuration data, and wherein the method further comprises the step of converting the sensor system using the set of machine-readable configuration data.

44. The method of claim 40, wherein the specified configuration specifies an arrangement of keys for an image of a keyboard.

45. The method of claim 44, wherein the specified configuration specifies a position of a mouse pad region that is to be displayed with the keyboard.

46. The method of claim 44, wherein the keyboard is in a QWERTY form.

47. The method of claim 40, further comprising the step of:
identifying a plurality of distinct regions specified by the representation; and
identifying a property specified for each of the plurality of distinct regions.

48. The method of claim 47, wherein the step of converting the representation of the configuration into a second form includes assigning a first region in the plurality of distinct regions to a first property specified for that first region.

49. The method of claim 48, wherein assigning a first region in the plurality of distinct regions to a first property specified for that first region includes identifying a type of contact by the object on the first region that is to be interpreted as an input.

50. The method of claim 49, wherein identifying a type of contact by the object on the first region includes identifying whether one or more of a movement, a single-tap, or a double-tap is to be interpreted as the input.

51. The method of claim 48, further comprising assigning a first region in the plurality of distinct regions to a first input value.

52. A method for providing a light-generated input interface, the light-generated input interface including a projector for projecting an image of the input interface, and a sensor system to detect user interaction with the input interface, the method comprising:
receiving an output file from a diffractive optical element of the projector, the output file providing information about an image of the input interface that is to appear on a surface;
creating a simulated image of the input interface based on the information provided by the output file;
editing the simulated image; and
converting the edited simulated image into a form for configuring the projector.

53. The method of claim 52, wherein editing the simulated image includes automatically editing the image by comparing a desired image of the interface to the simulated image of the input interface.

54. The method of claim 52, further comprising filtering the information contained in the output file in order to perform the step of creating a simulated image.

55. The method of claim 52, further comprising using the information contained in the output file to generate a new output file having coordinates of pixels that are either lit or unlit.

56. The method of claim 52, wherein editing the image includes altering a state of selected individual pixels.
